(19) United States
(12) Patent Application Publication
(10) Pub. No.: US 2020/0182207 A1
(43) Pub. Date: Jun. 11, 2020

(54) SLEEVE FOR A FILTER ASSEMBLY

(71) Applicant: Caterpillar Inc., Deerfield, IL (US)

(72) Inventor: Philip C. SPENGLER, Washington, IL (US)

(73) Assignee: Caterpillar Inc., Deerfield, IL (US)

(21) Appl. No.: 16/216,443

(22) Filed: Dec. 11, 2018

(51) Int. Cl. F02M 37/34; B01D 29/11; B01D 29/25; F04B 53/20

(52) U.S. Cl. CPC F02M 37/34; B01D 29/111; B01D 29/25; F04B 53/20; B01D 29/118; B01D 2201/325; B01D 2201/184; B01D 2201/188; B01D 2201/30; B01D 2201/31; B01D 2201/0407

(57) ABSTRACT

A filter assembly includes a housing with an inlet and an outlet. The filter assembly also includes a tubular filter element located downstream of the inlet and upstream of the outlet and a sleeve element surrounding and blocking at least a portion of the filter element.

### TECHNICAL FIELD

The present disclosure relates generally to fluid filters, and more particularly, to a sleeve for a fluid filter assembly.

### BACKGROUND

Fluid filters are often used in earth moving equipment, construction equipment, mining equipment, and the like to remove contaminants from various fluids used to power, lubricate, drive, and control the mechanisms and engines of the equipment. Over time, contaminants collect in the fluids that may be detrimental to the components of the mechanisms and engines, necessitating repair, but fluid filters help to remove the contaminants in the fluids to prolong the useful life of the associated components. In one aspect, various types of machines use hydraulic systems to drive and control various implements or systems. The hydraulic systems often require clean hydraulic fluid in order for the systems to operate efficiently over long periods of time without malfunction or wear. For example, hydraulic fluid tanks may be difficult to clean and may contain dirt, residue, or particulate material, or the hydraulic fluid may come in contact with other particulate material during operation. The hydraulic fluid may be pressurized by a pump, and the particulate material in the hydraulic fluid may damage such hydraulic pumps. In another example, fuel may come into contact with particulate matter, which may be filtered out before the fuel is pumped or consumed by an engine. As such, hydraulic and fuel systems commonly include one or more filters upstream and/or downstream of the hydraulic or fuel pumps, and the flow rate parameters of the one or more filters are often important considerations in the manufacture and assembly of the hydraulic and fuel systems.

An exemplary hydraulic fluid filter is disclosed in U.S. Pat. No. 6,110,368 (“the '368 patent”) to Hopkins et al. The '368 patent discloses a hydraulic fluid filter apparatus that includes a housing with a porous element separating an inner channel and an outer channel to filter hydraulic fluid flowing from one channel to the other. The porous element includes a plurality of fluid flow grooves. The hydraulic fluid filter of the '368 patent may include one or more sleeves around the porous member to vary the compression of the filter and thus vary the cross-sectional area of fluid flow grooves in the porous member. As such, the one or more sleeves may vary the filtering conditions of the porous member. While the fluid filter of the '368 patent may be suitable for some applications, it may not be suitable for other applications. One or more features of the disclosed fluid filter assembly may solve one or more of the problems set forth above and/or other problems in the art. The scope of the current disclosure, however, is defined by the attached claims, and not by the ability to solve any specific problem.

### SUMMARY

In one aspect, a filter assembly may include a housing with an inlet and an outlet. The filter assembly may also include a tubular filter element located downstream of the inlet and upstream of the outlet and a sleeve element surrounding and blocking at least a portion of the filter element.

In another aspect, a filter assembly may include a tubular filter element defining an unfiltered area and a filtered area, and a sleeve element surrounding and blocking at least a portion of the tubular filter element. The sleeve element may include at least one or more openings providing greater flow of a fluid to the filter element at one end of the tubular filter element than at another end of the tubular filter element.

In a further aspect, a filter assembly may include a tubular filter element and a sleeve element surrounding and blocking at least a portion of the filter element. The sleeve element may include a plurality of through-holes arranged in groups, and the through-holes of each group of through-holes may increase in size from a first end of the sleeve to a second end of the sleeve.

### BRIEF DESCRIPTION OF THE DRAWINGS

FIG. 1 is a cross-sectional view of a filter assembly according to aspects of this disclosure.

FIG. 2 is a cross-sectional view of another filter assembly according to aspects of this disclosure.

FIG. 3 is perspective view of an exemplary filter sleeve of the filter assembly of FIG. 2.

### DETAILED DESCRIPTION

Both the foregoing general description and the following detailed description are exemplary and explanatory only and are not restrictive of the features, as claimed. As used herein, the terms “comprises,” “comprising,” “having,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. For the purpose of this disclosure, the term “fluid” is broadly used to refer to all types of fluids, including liquids or gases that may be filtered in a machine or equipment (e.g., hydraulic fluid, oil, gasoline, air, etc.). Moreover, in this disclosure, relative terms, such as, for example, “about,” “generally,” “substantially,” and “approximately” are used to indicate a possible variation of ±10% in the stated value.

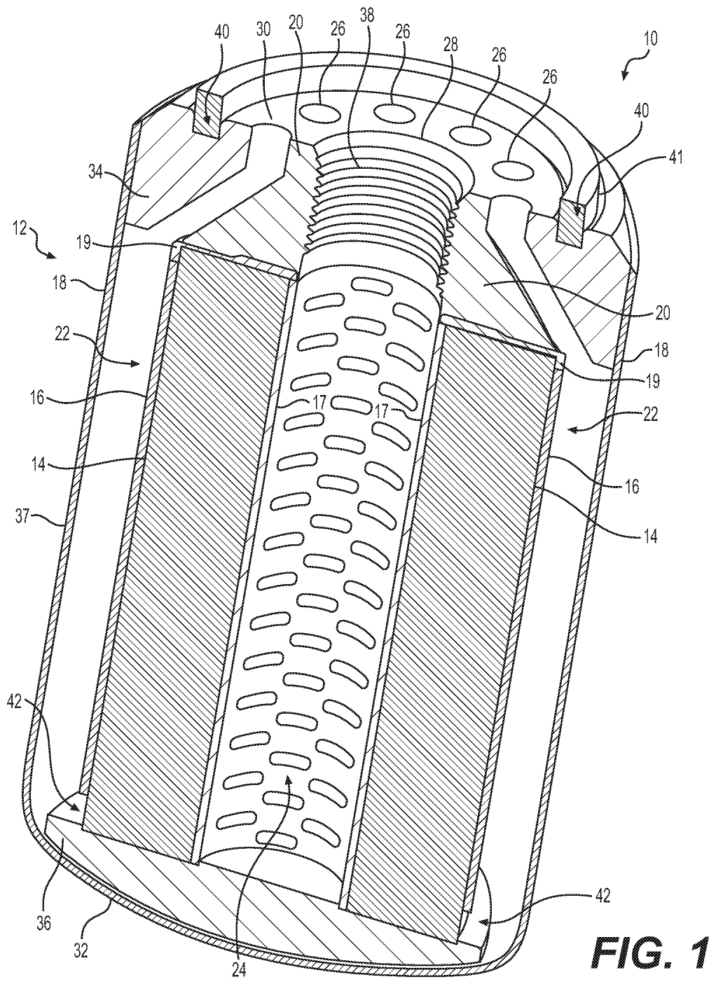

FIG. 1 illustrates a cross-sectional view of a portion of a filter assembly 10, for example, a hydraulic fluid or fuel filter assembly, according to aspects of the present disclosure. Filter assembly 10 includes a housing 12 enclosing a tubular filter element or filter media, i.e., filter 14. Filter 14 may be at least partially surrounded by a sleeve 16 such that sleeve 16 blocks at least a portion of filter 14. Additionally, filter assembly 10 may include an inner support 17 positioned radially within filter 14. Inner support 17 may include a plurality of through-holes, which may help block or separate particulate matter. One or more of filter 14, sleeve 16, and inner support 17 may be coupled or held in place by a top cap 19 and an end cap 36. For example, one or more of filter 14, sleeve 16, and inner support 17 may be potted, adhered, or otherwise coupled to top cap 19 and/or end cap 36. Housing 12 may include an outer wall 18 and an inner wall 20 spaced away from outer wall 18. Filter 14 may be positioned within outer wall 18 at least partially aligned with inner wall 20 such that filter assembly 10 defines an outer cavity 22 and an inner cavity 24, where filter 14 and inner wall 20 separate outer cavity 22 and inner cavity 24. Housing 12 may further include one or more inlets 26 in fluid communication with the outer cavity 22 and an outlet 28 in fluid communication with inner cavity 24. Therefore, filter 14 may filter fluid as the fluid flows from outer cavity 22 into inner cavity 24. Sleeve 16 may control or help disperse the flow of the fluid through filter 14.

Although sleeve 16 is shown as surrounding a portion of filter 14 on an outer face of filter 14, sleeve 16 may alternatively or additionally be positioned on an inner face of filter 14 or within a portion of filter 14. Similarly, while this disclosure discusses fluid flowing from one or more inlets 26 through outer cavity 22, filter 14, and inner cavity 24 to outlet 28, this disclosure is not so limited. For example, the flow through filter 14 may be reversed, with fluid being delivered via outlet 28 and flowing through inner cavity 24, filter 14, and outer cavity 22 to one or more inlets 26. The flow direction may depend on the type of fluid being filtered, the type of fluid system, or other aspects of the machine.

Housing 12 may include a substantially cylindrical shape with a top surface 30 and a bottom surface 32, and outer wall 18 and inner wall 20 may each include a substantially cylindrical shape. The one or more inlets 26 and outlet 28 may extend from top surface 30 to outer cavity 22 and inner cavity 22 within housing 12. Housing 12 may include a top portion 34 and an outer shell or sheath 37. Top portion 34 may be configured to be coupled to a machine or fluid system. Outer sheath 37 may be formed of a metal and may be sealed around at least a portion of top portion 34, for example, via crimping, an adhesive, etc. Outer sheath 37 may be fixedly coupled to top portion 34. Top surface 30 may include a groove 40 surrounding the one or more inlets 26. Moreover, outlet 28 may include a threading 38 or other coupling interface in an inner wall of the opening in top surface 30 of housing 12 that forms outlet 28. Groove 40 and/or threading 38 may help couple or seal filter assembly 10 to a fluid system. Groove 40 may include a gasket 41 to help couple or seal filter assembly 10 to the fluid system.

Although housing 12 is shown as substantially cylindrical, this disclosure is not so limited. Housing 12 may be any shape or configuration to surround or enclose filter 14 and sleeve 16 to form filter assembly 10.

Filter 14 may be a separate component removably positioned within housing 12, or may be integrally formed with housing 12. Filter 14 may be formed by weaving, injection molding, three-dimensional printing, or another appropriate formation process. Filter 14 includes a filtering material in a tubular shape. The filtering material may be a permeable material, such as a fabric, a plastic, a woven material, a non-woven material, or a combination of any of these materials or other filtering materials. As such, filter 14 may define a plurality of pores (not shown) that allow for the fluid (e.g., hydraulic fluid or fuel) to pass through filter 14. The plurality of pores may be any suitable size such that contaminants are not able to pass through filter 14, while allowing for a fluid flow rate through filter 14. Although not shown, filter 14 may also include a plurality of different filters provided in a concentric manner to provide multi-staged filtering. Moreover, filter 14 may include a core on an inner circumference that may help to support or add structure to filter 14.

Sleeve 16 may be a cylindrical sleeve that surrounds and blocks a portion of an exterior of filter 14. Sleeve 16 may be formed by injection molding, three-dimensional printing, or another appropriate formation process. Sleeve 16 may be made of a material that is less permeable than the material that comprises filter 14. For example, sleeve 16 may be made of a polymer or impermeable plastic. An inner circumference of sleeve 16 may substantially match or be slightly larger than an outer circumference of filter 14.

Inner support 17 may be positioned radially within filter 14. Inner support 17 may be formed of a substantially impermeable material, with a plurality of evenly sized and spaced holes or openings to help block or separate particulate matter from the filtered fluid. Inner support 17 may help to support or position filter 14 within housing 12, and inner support 17 may be coupled to filter 14 and portions of housing 12 via an adhesive, friction fit, or other coupling.

Although filter 14, sleeve 16, and inner support 17 are shown as being substantially cylindrical, this disclosure is not so limited. For example, filter 14, sleeve 16, and inner support 17 may be substantially oval or elliptical, rectangular, pentagonal, hexagonal, octagonal, etc. Filter 14 and inner support 17 may be coupled between (e.g., potted within, adhered to, etc.) portions of top portion 34 (e.g., inner wall 20 or top cap 19) and end cap 36. Sleeve 16 may then be positioned around filter 14. Sleeve 16 may be sized to be friction fit around filter 14. For example, an inner diameter of sleeve 16 may be approximately the same size or slightly greater than an outer diameter of filter 14. Alternatively or additionally, filter assembly 10 may include an adhesive between a portion of sleeve 16 and filter 14 to secure sleeve 16 around filter 14. Alternatively, filter 14, sleeve 16, and inner support 17 may be manufactured together and installed as one unitary element (e.g., potted within a portion of top cap 19 and/or end cap 36) and/or one or more of filter 14, sleeve 16, and inner support 17 may be manufactured together with one or more portions of housing 12.

As shown in FIG. 1, sleeve 16 may cover the circumferential exterior of filter 14 except for a bottom portion of filter 14. For example, filter 14 may include a filter length from a position at the top of filter slot 22 to the bottom of inner wall 20, and sleeve 16 may include a sleeve length that is less than the filter length. For example, the sleeve length may be approximately 40%, 45%, 50%, 55%, 60%, 65%, 70%, 75%, 80%, 85%, 90%, or 95% of the filter length. In this aspect, sleeve 16 may form an opening or gap 42 between sleeve 16 and the interior of bottom portion 32 or end cap 36, which may direct any fluid in outer cavity 22 into inner cavity 24 through the bottom portion of filter 14. As the fluid flows through filter 14, the fluid may flow through gap 42 and percolate through the entirety of filter 14 and into inner cavity 24. Therefore, even though the fluid may be delivered into a top portion of outer cavity 22 via inlets 26, the fluid may be distributed throughout the entirety of filter 14.

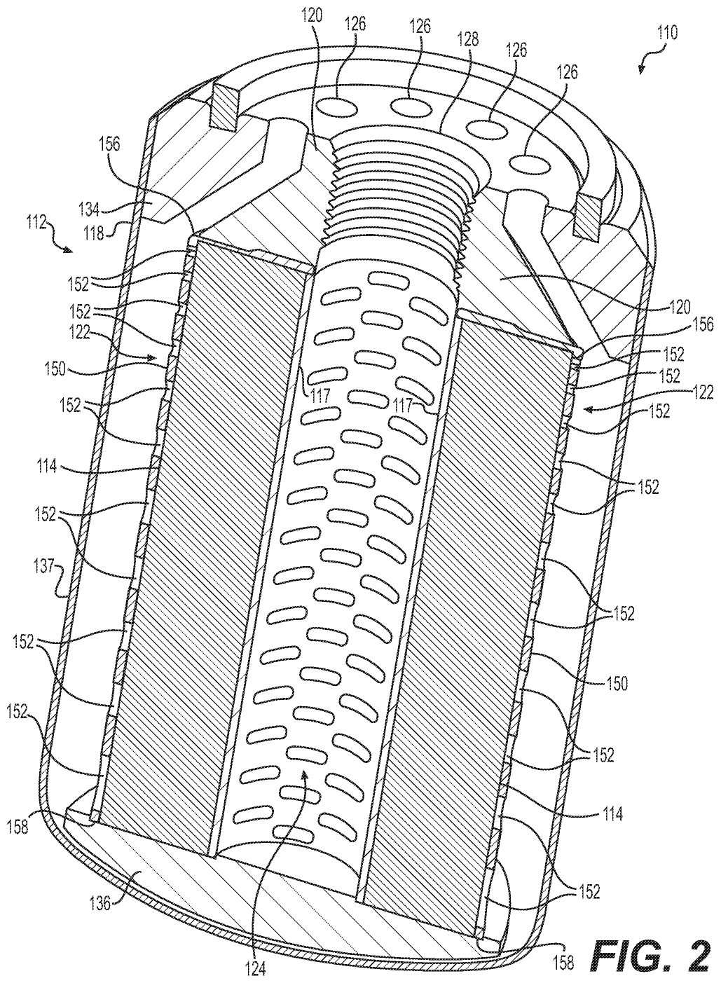

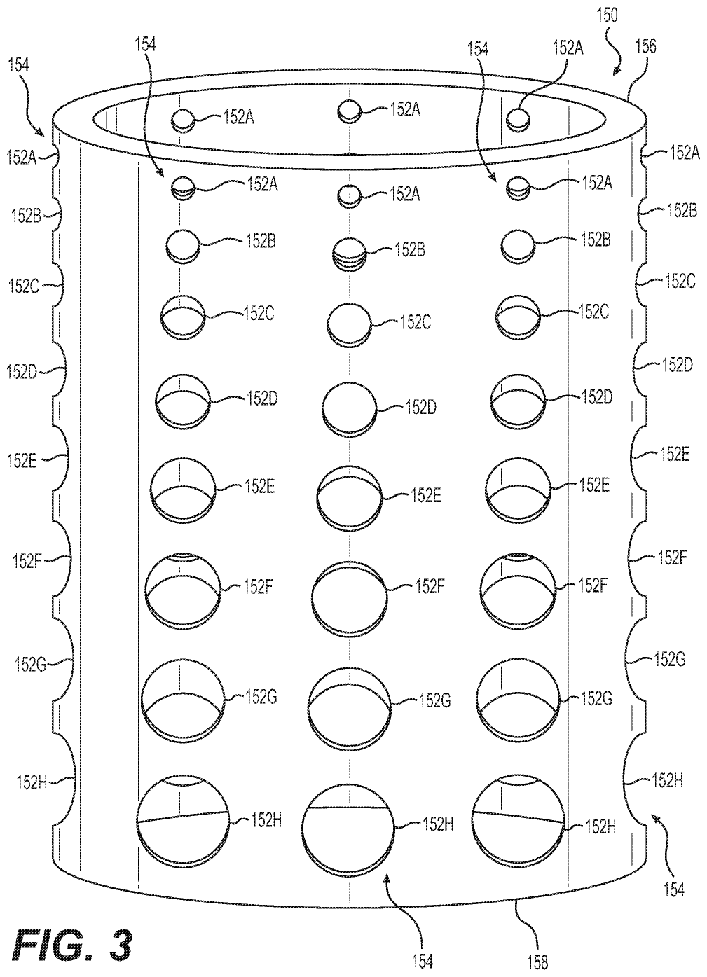

FIG. 2 illustrates an alternative example with similar elements to filter assembly 10 shown by 100 added to the reference numbers. Specifically, FIG. 2 illustrates a cross-sectional view of a filter assembly 110. Filter assembly 110 includes a housing 112 enclosing a filter 114 and an inner support 117 that separates an outer cavity 122 and an inner cavity 124, as discussed above. Filter assembly 110 includes a sleeve 150 surrounding at least a portion of filter 114. In one aspect, sleeve 150 may extend a length of filter 114 that is exposed to outer cavity 122. Sleeve 150 may be made of a similar material as sleeve 16, but also includes a plurality of through-holes 152 along a length of sleeve 150. The plurality of through-holes 152 may be arranged in groups 154 (FIG. 3), and may change in size over the longitudinal length of sleeve 150. In this aspect, and as shown in greater detail in FIG. 3, a top portion 156 of sleeve 150, for example, closer to inner wall 120, may include a smaller through-hole 152A, and a bottom portion 158 of sleeve 150, for example, closer to the interior of end cap 136, may include a larger through-hole 152H. The size of through-holes 152 may be a gradient, in that through-holes 152 may get progressively larger from the top portion 156 to the bottom portion 158 of sleeve 150.

FIG. 3 illustrates a perspective view of sleeve 150. As shown, sleeve 150 includes a plurality of through-holes 152 that extend entirely through a radial thickness of sleeve 150. For example, sleeve 150 may include several groups 154 of through-holes 152 around the circumference of sleeve 150. Each group 154 of through-holes 152 may extend from the top portion 156 of sleeve 150 to the bottom portion 158 of sleeve 150, with the through-holes 152 of each group 154 increasing in size from the top portion 156 to the bottom portion 158 of sleeve 150. As shown in FIGS. 2 and 3, each group 154 of through-holes 152 may include eight through-holes 152. Additionally, each group 154 may include any number of through-holes 152, for example, two, three, four, five, six, seven, nine, ten, etc. through-holes 152. Although each through-hole 152 is shown as substantially circular in FIGS. 2 and 3, this disclosure is not so limited. For example, through-holes 152 may be oval, triangular, rectangular, pentagonal, or any other appropriate shape.

In one aspect, successive through-holes 152 of each group 154 of through-holes 152 may be approximately 10%, 20%, 30%, 40%, 50%, etc. larger than the preceding through-holes 152. For example, through-hole 152B may be approximately 30% larger than through-hole 152A, and through-hole 152C may be approximately 30% larger than through-hole 152B. The change in size may be consistent between successive through-holes 152, or may be varied between different pairs of successive through-holes 152. Moreover, the groups 154 of through-holes 152 may be evenly spaced around the circumference of sleeve 150. As shown in FIG. 3, groups 154 of through-holes 152 may be spaced approximately 45 degrees apart around the circumference of sleeve 150. In other examples, groups 154 of through-holes 152 may be spaced approximately 180 degrees, 120 degrees, 90 degrees, 72 degrees, 60 degrees, 37.5 degrees, 30 degrees, 15 degrees, 10 degrees, 5 degrees, etc. over the circumference of sleeve 150, and sleeve 150 may include the corresponding number of groups 154 of through-holes 152. Although groups 154 of through-holes 152 are shown in FIGS. 2 and 3 as extending vertically in rows from one end of filter 114 to the other end, this disclosure is not so limited. For example, through-holes 152 may be positioned in a spiral arrangement, a zig-zag arrangement, or any other arrangement.

Sleeve 150 may fit on or around filter 114 as discussed with respect to FIGS. 1 and 2. Additionally, through-holes 152 through sleeve 150 may allow any fluid in outer cavity 122 to flow through filter 114 and into inner cavity 124. Because sleeve 150 includes a gradient of through-holes 152, sleeve 150 may direct a greater amount of fluid through the larger through-holes 152, such that the fluid may be distributed through filter 114. As the fluid flows through filter 114, the fluid may percolate through the entirety of filter 114 and into inner cavity 124. Therefore, even though the fluid may be delivered into a top portion of outer cavity 122 via inlets 126, the fluid may flow through through-holes 152 and may be distributed throughout the entirety of filter 114. Any filtered out particulate material may be retained in filter 114 and/or outer cavity 122.

### INDUSTRIAL APPLICABILITY

The disclosed aspects of filter assemblies 10 and 110 may be used in any machine that includes a fluid system that includes one or more filters. Filter assemblies 10 and 110 described herein may provide for a more efficient distribution of fluid flow through filtering elements, with a reduced number of components and lower likelihood of requiring maintenance or replacement. Therefore, the disclosed filter assemblies 10 and 110 may be reliable and low cost, without sacrificing performance.

Sleeves 16 and 150 help to direct the flow of a fluid through filter assembly 10, 110. With sleeve 16 or sleeve 150 abutting filter 14, 114, either interior or exterior to filter 14, 114, sleeve 16 or sleeve 150 may modify the flow path and/or flow rate of fluid through filter 14, 114. For example, fluid flowing from the one or more inlets 26, 126 may flow into outer cavity 22, 122. Once within outer cavity 22, 122, fluid may flow through gap 42 formed by sleeve 16 and bottom portion 36 (FIG. 1) or through through-holes 152 in sleeve 150 (FIG. 2) and into filter 14, 114. Once fluid is within filter 14, 114, the fluid may percolate through filter 14, 114 and into inner cavity 24, 124. As fluid flows into inner cavity 24, 124 through gap 42 and through-holes 152, a lower pressure may develop within inner cavity 24, 124 on a side opposite to gap 42 and the larger through-holes 152. Accordingly, fluid may percolate and flow through the entirety of filter 14, 114 and into inner cavity 24, 124. Additionally, as discussed with respect to FIGS. 2 and 3, through-holes 152 in sleeve 150 may increase in size in a direction extending away from inlets 126. Fluid may be delivered by inlets 126, with inlets 126 being closest to the smaller through-holes 152. As such, there may be a higher fluid pressure in outer cavity 122 near inlets 126. Nevertheless, the gradient of through-holes (e.g., larger through-holes 152 being positioned farther away from inlets 126) may help to distribute the fluid through the entirety of filter 114. Therefore, even though the fluid may be pressurized and delivered into a top portion of outer cavity 22, 122 via inlets 26, 126, the fluid may be distributed throughout the entirety of filter 14, 114.

Sleeves 16 and 150 may help to prolong the lifetime of filters 14, 114. For example, by distributing the flow of the fluid through the entirety of filters 14, 114, the filters may filter a larger amount of fluid without a decrease in filtering capabilities or flow rate. Additionally, sleeves 16 and 150 may help distribute fluid through filters 14, 114, which may allow for a greater volume or higher pressure of fluid to be filtered over a period of time than a filter within filter assembly 10, 110 without a sleeve, which may provide for increased performance for the implement or machine on which filter assembly 10, 110 is coupled (e.g., hydraulic mechanisms or fuel-driven engines). Sheath 37, 137 may be crimped or otherwise fixedly sealed around top portion 34 to enclose filter 114, 114, sleeve 16, 150, and other internal components of filter assembly 10, 100 and form a disposable filter assembly. Alternatively or additionally, the flow rate, distribution, or other aspects of filter assembly 10, 110 may be modified by switching the filter 14, 114 or sleeve 16, 150. For example, a sleeve 16 that forms a larger gap 42 or a sleeve 150 that includes larger or greater number of through-holes 152 may help to increase a flow rate or flow volume through filter 14, 114.

It will be apparent to those skilled in the art that various modifications and variations can be made to the disclosed system without departing from the scope of the disclosure. Other embodiments of the system will be apparent to those skilled in the art from consideration of the specification and practice of the sleeve for a filter assembly disclosed herein. It is intended that the specification and examples be considered as exemplary only, with a true scope of the disclosure being indicated by the following claims and their equivalents.

What is claimed is:

1. A filter assembly, comprising
a housing including an inlet and an outlet;
a tubular filter element located downstream of the inlet and upstream of the outlet; and
a sleeve element surrounding and blocking at least a portion of the filter element.

2. The filter assembly of claim 1, further including an adhesive coupling the sleeve element around an exterior of the tubular filter element.

3. The filter assembly of claim 2, wherein the sleeve element surrounds approximately 50% of the tubular filter element.

4. The filter assembly of claim 2, wherein the sleeve element forms at least one opening between the sleeve element and a portion of the housing, and wherein the at least one opening is positioned on a side opposite to the inlet.

5. The filter assembly of claim 1, wherein the sleeve element includes a plurality of openings around the sleeve element.

6. The filter assembly of claim 5, wherein the plurality of openings are arranged in groups of through-holes, and wherein the through-holes of each group of through-holes increase in size from one end of the sleeve element to another end of the sleeve element.

7. The filter assembly of claim 6, wherein the through-holes of each group of through-holes increase in size in a direction away from the inlet.

8. The filter assembly of claim 7, wherein the through-holes of each group of through-holes increase by approximately 30% in the direction away from the inlet.

9. The filter assembly of claim 7, wherein the sleeve element is circular, and wherein each group of through-holes is spaced approximately 45 degrees apart around a circumference of the sleeve element.

10. The filter assembly of claim 1, wherein the sleeve element is formed of an impermeable material.

11. A filter assembly, comprising:
a tubular filter element defining an unfiltered area and a filtered area;
a sleeve element surrounding and blocking at least a portion of the tubular filter element;
wherein the sleeve element includes at least one or more openings providing greater flow of a fluid to the filter element at one end of the tubular filter element than at another end of the tubular filter element.

12. The filter assembly of claim 11, wherein the sleeve element is formed of an impermeable material.

13. The filter assembly of claim 12, wherein the sleeve element surrounds approximately 50% of the tubular filter element.

14. The filter assembly of claim 12, wherein the sleeve element includes a plurality of through-holes spaced around the circumference of the sleeve element.

15. The filter assembly of claim 14, wherein the plurality of through-holes are arranged in groups of through-holes, and wherein the through-holes of each group of through-holes increase in size from one side of the sleeve element to the other side of the sleeve element.

16. A filter assembly, comprising:
a tubular filter element; and
a sleeve element surrounding and blocking at least a portion of the filter element,
wherein the sleeve element includes a plurality of through-holes arranged in groups, and
wherein the through-holes of each group of through-holes increase in size from a first end of the sleeve to a second end of the sleeve.

17. The filter assembly of claim 16, wherein the sleeve element is formed of an impermeable material.

18. The filter assembly of claim 16, wherein the through-holes of each group of through-holes increase by at least 10% in the direction from the first end to the second end.

19. The filter assembly of claim 18, wherein the through-holes of each group of through-holes increase by at least 30% in the direction from the first end to the second end.

20. The filter assembly of claim 16, wherein each group of through-holes are arranged as a row, and each row is spaced approximately 45 degrees apart around a circumference of the sleeve element.
